(19) United States
(12) Patent Application Publication
(10) Pub. No.: US 2002/0159114 A1
(43) Pub. Date: Oct. 31, 2002

(54) Method and apparatus for routing signals through an optical network

(76) Inventors: Laxman Sahasrabuddhe, Santa Clara, CA (US); Biswanath Mukherjee, Davis, CA (US)

Correspondence Address: A. Richard Park, Park, Vaughan & Fleming LLP, 508 Second Street, Suite 201, Davis, CA, 95616, US

(21) Appl. No.: 09/836,958

(22) Filed: Apr. 17, 2001

(51) Int. Cl. H04J 14/00; H04J 14/02

(52) U.S. Cl. 359/117; 359/128

(57) ABSTRACT

One embodiment of the present invention provides a system for routing signals through an optical network, wherein the optical network includes a plurality of optical cross-connects coupled together by a plurality of optical fiber links. Note that each of the optical cross-connects includes a plurality of non-blocking switches, and each optical fiber link can carry signals on a plurality of wavelengths. Upon receiving a request to establish a path, the system identifies a plurality of paths between the source and the destination through the optical network. Each switch in an optical cross-connect is associated with one or more wavegroups (wherein each wavegroup includes signals from one or more wavelengths). Note that each path through the optical network is comprised of wavelength/fiber links that belong to the same wavegroup, and that wavelength/fiber links that belong to the same wavegroup are routed through a non-blocking switch that is associated with the wavegroup. Next, the system calculates a cost for each of the paths based upon a cost function, and selects a path based upon the calculated costs.

### BACKGROUND

1. Field of the Invention

The present invention relates to optical communication networks. More specifically, the present invention relates to a method and an apparatus for selecting a pathway through an optical network that includes optical cross-connects coupled together by fiber optic links.

1. Related Art

The explosive growth of the Internet and the recent proliferation of data-intensive applications, such as video-on-demand, have placed increasing demands on the existing network infrastructure. In order to keep pace with these increasing demands, communication networks have begun to use optical fibers to carry information. In order to utilize the full capacity of an optical fiber, data is often simultaneously transmitted on multiple wavelength-division-multiplexed (WDM) channels, wherein each WDM channel is transmitted on its own wavelength.

Simultaneously transmitting multiple data signals on different wavelengths greatly increases the capacity of an optical fiber. However, it also significantly complicates the problem of switching signals at the junction points between optical fibers.

Fiber optic networks are typically comprised of a number of optical cross-connects (OXCs) that are coupled together through optical fibers (for example, see FIG. 2). A message from a source is typically routed across a number of different optical fibers and a number of different optical cross-connects before arriving at a destination.

Each of these optical cross-connects switches signals between the different optical fibers. An exemplary optical cross-connect appears in FIG. 1. In this exemplary optical cross-connect, a number of optical fibers 122-125 feed into a number of demultiplexers 102-105. Demultiplexers 102-105 separate different wavelength-specific channels of data from the optical fibers, and the wavelength-specific channels of data are fed through a multi-stage Clos network containing non-blocking switches. Outputs of the non-blocking switches feed into multiplexers 112-115, which convert the outputs back into WDM optical signals. Note that the non-blocking switches in the first stage of the Clos network are used to switch 16 input signals into 31 output signals. This provides redundant communication pathways that allow more flexibility in routing signals through the optical cross-connect.

Also, note that the number of non-blocking switches in the Clos network is very large. If each non-blocking switch requires its own semiconductor chip, 159 semiconductor chips are required to implement the Clos network illustrated in FIG. 1. This large number of semiconductor chips greatly increases the size and cost of an optical cross-connect, and the number of interconnections within the Clos network, as well as increasing power consumption. Hence, large optical cross-connects that employ a multistage network tend to be expensive to produce and expensive to operate.

What is needed is a method and an apparatus for switching WDM optical signals without requiring the large numbers of switching elements found in a multistage switching network.

Additionally, what is needed is a process for selecting a pathway between a source and a destination through an optical switching network containing a plurality of optical cross-connects coupled together by a plurality of optical fiber links.

### SUMMARY

One embodiment of the present invention provides a system for routing signals through an optical network, wherein the optical network includes a plurality of optical cross-connects coupled together by a plurality of optical fiber links. Note that each of the optical cross-connects includes a plurality of non-blocking switches, and each optical fiber link can carry signals on a plurality of wavelengths. Upon receiving a request to establish a path, the system identifies a plurality of paths between the source and the destination through the optical network. Each switch in an optical cross-connect is associated with one or more wavegroups (wherein each wavegroup includes signals from one or more wavelengths). Note that each path through the optical network is comprised of wavelength/fiber links that belong to the same wavegroup, and that wavelength/fiber links that belong to the same wavegroup are routed through a non-blocking switch that is associated with the wavegroup. Next, the system calculates a cost for each of the paths based upon a cost function, and selects a path based upon the calculated costs.

In one embodiment of the present invention, each optical cross-connect includes a single column of non-blocking switches.

In one embodiment of the present invention, the cost of a given path is a function of a number of hops in the given path and the utilization of wavelength/fiber links in the given path.

In one embodiment of the present invention, the cost of the given path is a function of the utilization of wavegroup links along the given path, wherein a given wavegroup link includes all wavelengths belonging to a given wavegroup on a given optical fiber link.

In one embodiment of the present invention, selecting the path involves selecting a primary path and at least one backup path from the plurality of paths.

In one embodiment of the present invention, identifying the paths additionally involves considering paths that cross between wavegroups, wherein the cost of a given path that crosses between wavegroups includes an additional cost for switching between wavegroups.

In one embodiment of the present invention, identifying the paths involves using Djikstra's shortest path algorithm to find shortest paths based upon number of hops between the source and the destination.

In one embodiment of the present invention, identifying the paths involves identifying a plurality of link-disjoint paths.

### BRIEF DESCRIPTION OF THE FIGURES

FIG. 1 illustrates a prior art optical cross-connect.

FIG. 2 illustrates a network of optical cross-connects in accordance with an embodiment of the present invention.

FIG. 3 illustrates an optical cross-connect with a single stage of switching elements in accordance with an embodiment of the present invention.

FIG. 4 is a flow chart illustrating the process of setting up a call across an optical network in accordance with an embodiment of the present invention.

FIG. 5 is a flow chart illustrating the process of selecting a path through an optical network in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Optical Network

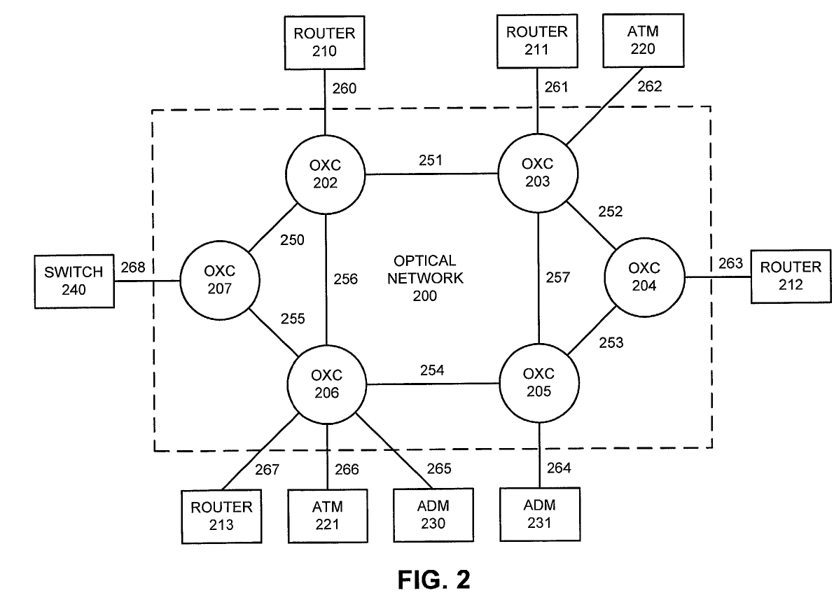

FIG. 2 illustrates an optical network 200 containing optical cross-connects 202-207 (OXCs) in accordance with an embodiment of the present invention. Optical cross-connects 202-207 are coupled to each other through a number of communications links 250-257. Each of these communication links 250-257 contains one or more optical fibers that carry wavelength-division multiplexed (WDM) signals between optical cross-connects 202-207.

Note that optical cross-connects 202-207 can be coupled to “edge devices,” such as Internet protocol (IP) routers 210-213, add-drop multiplexers (ADMs) 230-231, asynchronous transfer mode (ATM) switches 220-221, and other switches 240. Each of these edge devices is coupled either directly or indirectly to a number of computer systems or communications devices that send and receive communications through optical network 200.

By appropriately performing routing and wavelength assignments through optical cross-connects 202-207, an optical connection can be established to create logical (or virtual) neighbors out of edge devices that are geographically far apart in the network. For example, an optical connection can be established from router 213 to router 211 by establishing a connection that passes through communication link 267, optical cross-connect 206, communication link 254, optical cross-connect 205, communication link 257, optical cross-connect 203 and communication link 261. At each optical cross-connect along the way it is possible to switch the connection to a different wavelength on a different communication link.

Note that point-to-point optical connections are referred “lightpaths”, while point-to-multi-point optical connections are called “light-trees”. Also note that lightpaths can be both unidirectional and bi-directional.

Optical Cross-Connect with Single Stage of Switching Elements

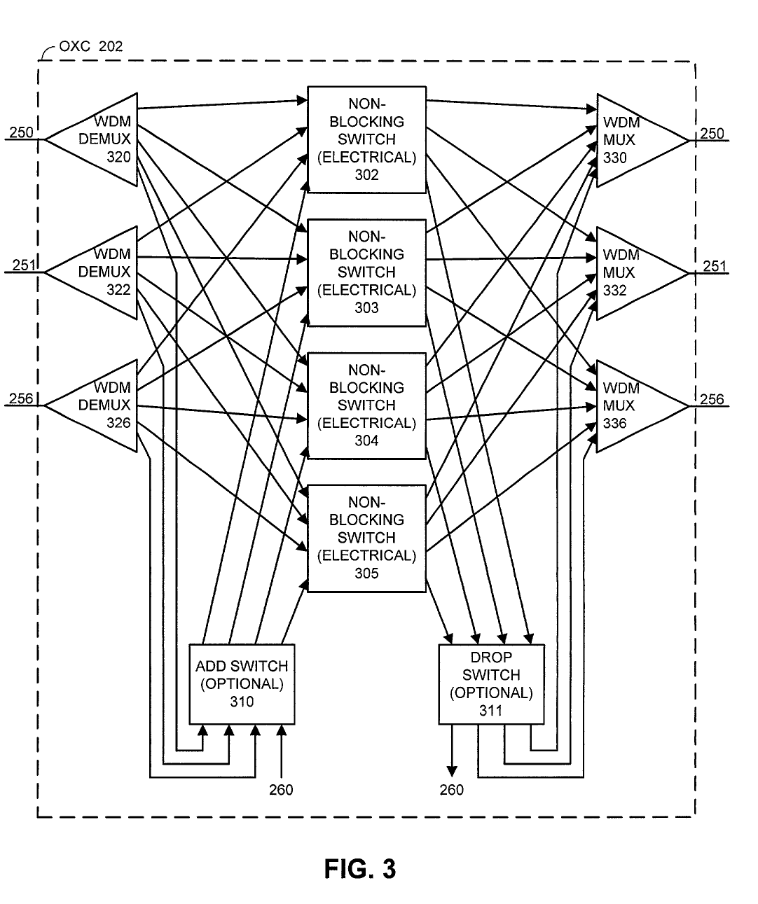

FIG. 3 illustrates an exemplary optical cross-connect 202 with a single stage of non-blocking switches in accordance with an embodiment of the present invention. Optical cross-connect 202 communicates through communication link 250 to optical cross-connect 207; through communication link 256 to optical cross-connect 206; and through communication link 251 to optical cross-connect 203. Optical cross-connect 203 also communicates with router 210 through communication link 260.

On the left-hand-side of FIG. 3, optical fibers from communication links 250, 251 and 256 feed into WDM demultiplexers 320, 322 and 326, respectively. Each of these WDM demultiplexers 320, 322 and 326 separates signals on different WDM channels carried on different frequencies on the optical fiber into separate outputs. These outputs are divided into a plurality of “wavegroups,” which include signals from one or more wavelengths. Signals for a given wavegroup are all routed to an associated non-blocking switch.

For example, in FIG. 3 WDM demultiplexers 320, 322 and 326 produce outputs that are divided into four wavegroups, and each wavegroup is directed to an associated one of the four non-blocking switches 302-305. Although FIG. 3 illustrates only one signal from each WDM demultiplexer being directed to each non-blocking switch, in general multiple signals associated with multiple wavelengths are directed from each WDM multiplexer to each non-blocking switch.

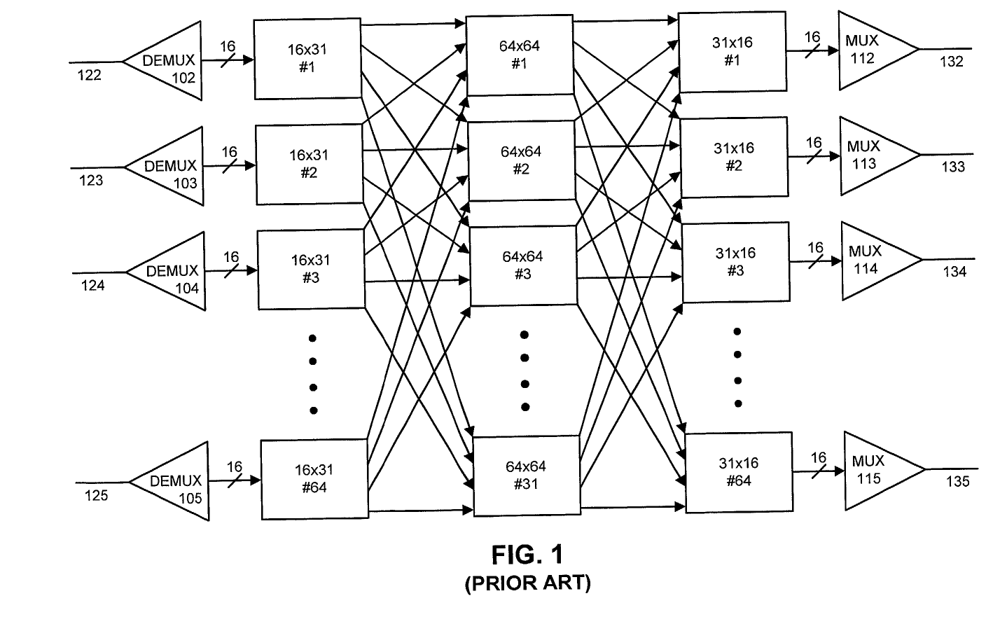

In the embodiment of the present invention illustrated in FIG. 1, the non-blocking switches are electrical. This means that a conversion between optical and electrical signals takes place at some point between WDM demultiplexers 320, 322 and 326 and non-blocking switches 302-305.

In one embodiment of the present invention, each of the WDM demultiplexers 320, 322 and 326 converts a WDM signal into a plurality of 1310 nanometer (nm) optical signals, wherein there is a separate 1310 nm optical signal for each WDM channel. (Note that instead of 1310 nm signals, different wavelength signals can also be used, such as 850 nm signals or 1510 nm signals.) Next, each of these 1310 nm optical signals feeds into a converter that converts the 1310 nm optical signal into an electrical signal that feeds into one of non-blocking switches 302-305.

Non-blocking switches 302-305 are used to switch inputs received from WDM demultiplexers 320, 322 and 326 into output signals that are distributed to WDM multiplexers 330, 332 and 336. In one embodiment of the present invention, non-blocking switches 302-305 are implemented using cross-bar switches.

WDM multiplexers 330, 332 and 336 convert the outputs of non-blocking switches 302-305 back into WDM optical form to produce WDM optical signals that feed through communication links 250, 251 and 256 to neighboring optical cross-connects, 207, 203 and 206, respectively. Note that at some point between non-blocking switches 302-305 and WDM multiplexers 330, 332 and 336, the electrical signals from non-blocking switches 302-305 are converted back into single-wavelength optical form.

Add/Drop Switches

The optical cross-connect illustrated in FIG. 3 can be optionally augmented to include add switch 310 and drop switch 311. Add switch 310 can receive inputs from WDM demultiplexers 320, 322 and 326, as well as from communication link 260 going to an edge device, such as router 210 (see FIG. 2). Add switch 310 switches these input signals to produce output signals that are routed to non-blocking switches 302-305.

Some of the outputs of non-blocking switches 302-305 become inputs to drop switch 311. Drop switch 311 switches these inputs to produce outputs that are directed to WDM multiplexers 330, 332 and 336, as well as to communication link 260, which is coupled to router 210.

Note that the combination of add switch 310 and drop switch 311 provide additional pathways through optical cross-connect 202 that can be used to augment the pathways that pass through only a single non-blocking switch.

Advantages

The new optical cross-connect illustrated in FIG. 3 has a number of advantages when compared with the prior art multistage network illustrated in FIG. 1. The new optical cross-connect uses considerably fewer chips and considerably fewer interconnections, which results in a much cheaper switch, which is easier to maintain. Of course, since the new switch has fewer redundant pathways it is more likely to block when the system attempts to establish a given connection. However, this blocking problem can often be overcome by carefully optimizing routes through multiple optical cross-connects within an optical network.

The present invention also has considerable advantages over solutions that use completely optical switching elements instead of electrical switches 302-305. This is because completely optical switching elements are constrained to switch signals that belong to the same wavelength, whereas the present invention can be used to establish connections between different wavelengths on different optical fibers. This is possible because each wavegroup generally contains signals from a number of different wavelengths. Hence, each non-blocking switch can be used to switch signals between the different wavelengths in the associated wavegroup.

Implementation

Note that an implementation of the hardware described in the previous section is generally larger than the example illustrated in FIG. 3. For example, in one embodiment of the present invention, an optical cross-connect that switches 1024 inputs between 1024 outputs is built out of a single column of eight 128×128 non-blocking switching elements. This optical cross-connect receives eight WDM optical inputs, and each of these WDM optical inputs is demultiplexed into 128 single-wavelength optical signals that feed into the 128×128 non-blocking switching elements. The outputs of the eight 128×128 non-blocking switching elements feed into eight 128-to-one WDM multiplexers.

In this embodiment, each of the eight WDM demultiplexers sends 16 single-wavelength inputs to each of the 128×128 switching elements. Conversely, each the of the eight 128×128 non-blocking switching elements sends 16 single-wavelength output signals to each of the 128-to-one WDM multiplexers.

In another embodiment of the present invention, one of the eight WDM demultiplexers is replaced with an add switch that receives inputs from the remaining seven WDM demultiplexers, as well as from various edge devices. Outputs from the add switch are routed to the eight 128×128 non-blocking switches. Similarly, one of the eight WDM multiplexers is replaced by a drop switch that receives input signals from the eight 128×128 non-blocking switches. Outputs from the drop switch are routed to the remaining seven 128-to-one multiplexers, as well as to the various edge devices.

Call Setup Process

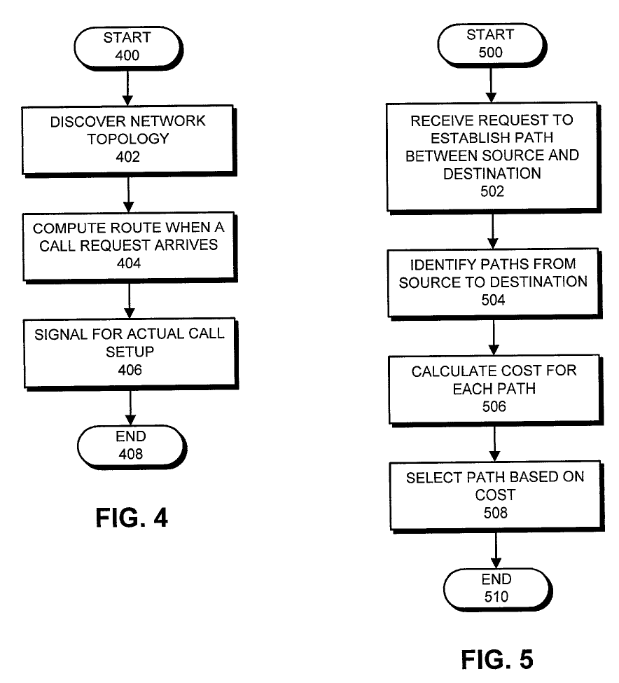

FIG. 4 is a flow chart illustrating the process of setting up a call across optical network 200 in accordance with an embodiment of the present invention. The system starts by discovering the network topology by employing a routing protocol, such as the Open Shortest Path First (OSPF) protocol (step 402). Next, when a call request arrives, the system computes a route for the call (step 404). This generally involves computing a route through multiple optical-cross-connects that comprise optical network 200. Finally, the system sets up a call by employing a protocol, such as the Multi-Protocol Label Switching (MPLS) protocol (step 406). At this point the call (or connection) is established across optical network 200.

Path Selection

FIG. 5 is a flow chart illustrating the process of computing a route through an optical network in accordance with an embodiment of the present invention. Note that the flow chart illustrated in FIG. 5 describes the operations involved in performing step 404 of FIG. 4.

The system first receives a request to establish a path between a source and a destination through the optical network (step 502). Next, the system uses information from a link-state database to identify one or more paths between the source and the destination (step 504). This can be accomplished by using Djikstra's shortest path algorithm to find shortest paths based upon number of hops between the source and the destination, although, in general, any method for finding paths can be used. For fault-tolerance purposes, the system may find both a primary path and a backup path.

In one embodiment of the present invention, the system finds one or more link-disjoint paths. This is accomplished by (a) running Djikstra's shortest path algorithm to find the shortest path. (b) If no shortest path is found, the system exits. (c) Otherwise, the system removes all optical fiber links in the shortest path and returns to step (a).

The system generally looks for paths that are wavegroup-continuous, which means that all wavelength/fiber links in the path belong to the same wavegroup. Recall that each switch in an optical cross-connect is associated with one or more wavegroups. Furthermore, note that each path through the optical network is comprised of wavelength/fiber links that belong to the same wavegroup, and that wavelength/fiber links that belong to the same wavegroup are routed through a non-blocking switch that is associated with the wavegroup. For example, in FIG. 3, all signals coming from WDM demultiplexers 320, 322 and 326 into non-blocking switch 302, and all signals going from non-blocking switch 302 into WDM multiplexers 330, 332 and 336 belong to the same wavegroup. Since switch 302 is non-blocking, any input belonging to the associated wavegroup can always be routed to any output belonging to the same wavegroup. This fact greatly simplifies the process of finding a route through the optical network because the possibility of blocking within optical cross-connects does not have to be considered.

Note that the switch illustrated in FIG. 3 includes four non-blocking switches 302-305, which are each associated with a different wavegroup. Each wavegroup can be thought of as defining a separate network that operates within the topology defined by the fiber optic links in the optical network.

Also note that add switch 310 and drop switch 311 can be used to switch paths between wavegroups if such switching is advantageous. However, in switching between wavegroups, possible blocking within optical cross-connects may have to be considered during the routing process. Also, an additional cost may be added to the cost function described below to account for the switching.

Next, the system calculates the cost for each identified path/wavegroup pair (step 506). This can involve using any one of a number of different cost functions. In one embodiment of the present invention, the cost of a given path/wavegroup pair is a function of a number of hops in the given path and the utilization of wavelength/fiber links in the given path/wavegroup pair.

In a variation on the above embodiment, the cost of the given path/wavegroup pair is a function of the utilization of wavegroup links along the given path. Note that a wavegroup link includes all wavelengths belonging to the same wavegroup on a given optical fiber link. For example, if a given optical fiber link carries four wavelengths belonging to the same wavegroup, and three of these wavelengths are presently used, the utilization of the wavegroup link is 0.75. Note that by considering utilization in the cost function, the system tends not to select congested wavegroup links.

Finally, the system selects a path based upon the calculated costs of the path (step 508). Note that this can involve selecting a primary path and at least one backup path to be used for fault tolerance purposes. In this case, the primary path and backup path are selected based upon the combined cost of the primary path and backup path.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for routing signals through an optical network, wherein the optical network includes a plurality of optical cross-connects coupled together by a plurality of optical fiber links, wherein each optical cross-connect includes a plurality of non-blocking switches, and wherein each optical fiber link can carry signals on a plurality of wavelengths, the method comprising:
receiving a request to establish a path between a source and a destination;
identifying a plurality of paths between the source and the destination through the optical network;
wherein each of the plurality of paths is comprised of wavelength/fiber links that belong to the same wavegroup;
wherein wavelength/fiber links that belong to the same wavegroup are routed through the same non-blocking switch at each optical cross-connect;
calculating a cost for each of the plurality of paths based upon a cost function; and
selecting the path from the plurality of paths based upon the calculated costs.

2. The method of claim 1, wherein each optical cross-connect in the plurality of optical cross-connects includes a single column of non-blocking switches.

3. The method of claim 1, wherein the cost of a given path is a function of a number of hops in the given path and the utilization of wavelength/fiber links in the given path.

4. The method of claim 3, wherein the cost of the given path is a function of the utilization of wavegroup links along the given path, wherein a given wavegroup link includes all wavelengths belonging to a given wavegroup on a given optical fiber link.

5. The method of claim 1, wherein selecting the path involves selecting a primary path and at least one backup path from the plurality of paths.

6. The method of claim 1,
wherein identifying the plurality of paths additionally involves considering paths that cross between wavegroups; and
wherein the cost of a given path that crosses between wavegroups includes an additional cost for switching between wavegroups.

7. The method of claim 1, wherein identifying the plurality of paths involves using Djikstra's shortest path algorithm to find shortest paths based upon number of hops between the source and the destination.

8. The method of claim 1, wherein identifying the plurality of paths involves identifying a plurality of link-disjoint paths.

9. A computer-readable storage medium storing instructions that when executed by a computer cause the computer to perform a method for routing signals through an optical network, wherein the optical network includes a plurality of optical cross-connects coupled together by a plurality of optical fiber links, wherein each optical cross-connect includes a plurality of non-blocking switches, and wherein each optical fiber link can carry signals on a plurality of wavelengths, the method comprising:
receiving a request to establish a path between a source and a destination;
identifying a plurality of paths between the source and the destination through the optical network;
wherein each of the plurality of paths is comprised of wavelength/fiber links that belong to the same wavegroup;
wherein wavelength/fiber links that belong to the same wavegroup are routed through the same non-blocking switch at each optical cross-connect;
calculating a cost for each of the plurality of paths based upon a cost function; and
selecting the path from the plurality of paths based upon the calculated costs.

10. The computer-readable storage medium of claim 9, wherein each optical cross-connect in the plurality of optical cross-connects includes a single column of non-blocking switches.

11. The computer-readable storage medium of claim 9, wherein the cost of a given path is a function of a number of hops in the given path and the utilization of wavelength/fiber links in the given path.

12. The computer-readable storage medium of claim 11, wherein the cost of the given path is a function of the utilization of wavegroup links along the given path, wherein a given wavegroup link includes all wavelengths belonging to a given wavegroup on a given optical fiber link.

13. The computer-readable storage medium of claim 9, wherein selecting the path involves selecting a primary path and at least one backup path from the plurality of paths.

14. The computer-readable storage medium of claim 9,
wherein identifying the plurality of paths additionally involves considering paths that cross between wavegroups; and
wherein the cost of a given path that crosses between wavegroups includes an additional cost for switching between wavegroups.

15. The computer-readable storage medium of claim 9, wherein identifying the plurality of paths involves using Djikstra's shortest path algorithm to find shortest paths based upon number of hops between the source and the destination.

16. The computer-readable storage medium of claim 9, wherein identifying the plurality of paths involves identifying a plurality of link-disjoint paths.

17. An apparatus for routing signals through an optical network, wherein the optical network includes a plurality of optical cross-connects coupled together by a plurality of optical fiber links, wherein each optical cross-connect includes a plurality of non-blocking switches, and wherein each optical fiber link can carry signals on a plurality of wavelengths, the apparatus comprising:
an identification mechanism that is configured to identify a plurality of paths between a source and a destination through the optical network;
wherein each of the plurality of paths is comprised of wavelength/fiber links that belong to the same wavegroup;
wherein wavelength/fiber links that belong to the same wavegroup are routed through the same non-blocking switch at each optical cross-connect;
a calculating mechanism that is configured to calculate a cost for each of the plurality of paths based upon a cost function; and
a selection mechanism that is configured to select the path from the plurality of paths based upon the calculated costs.

18. The apparatus of claim 17, wherein each optical cross-connect in the plurality of optical cross-connects includes a single column of non-blocking switches.

19. The apparatus of claim 17, wherein the cost of a given path is a function of a number of hops in the given path and the utilization of wavelength/fiber links in the given path.

20. The apparatus of claim 19, wherein the cost of the given path is a function of the utilization of wavegroup links along the given path, wherein a given wavegroup link includes all wavelengths belonging to a given wavegroup on a given optical fiber link.

21. The apparatus of claim 17, wherein the selection mechanism is configured to select a primary path and at least one backup path from the plurality of paths.

22. The apparatus of claim 17,
wherein the identification mechanism is configured to consider paths that cross between wavegroups; and
wherein the cost of a given path that crosses between wavegroups includes an additional cost for switching between wavegroups.

23. The apparatus of claim 17, wherein the identification mechanism is configured to use Djikstra's shortest path algorithm to find shortest paths based upon number of hops between the source and the destination.

24. The apparatus of claim 17, wherein the identification mechanism is configured to identify a plurality of link-disjoint paths.
